(19) United States
(12) Patent Application Publication
(10) Pub. No.: US 2024/0359908 A1
(43) Pub. Date: Oct. 31, 2024

(54) SYSTEMS FOR DETECTING AND PICKING UP A WASTE RECEPTACLE

(71) Applicant: Oshkosh Corporation, Oshkosh, WI (US)

(72) Inventors: Leo Van Kampen, Conestogo (CA); Umang Patel, Oshkosh, WI (US); Jake Solberg, Oshkosh, WI (US); Jeff Meyer, Oshkosh, WI (US); Eric Codega, Oshkosh, WI (US); Jamsel Bualat, Oshkosh, WI (US)

(73) Assignee: Oshkosh Corporation, Oshkosh, WI (US)

(21) Appl. No.: 18/642,328

(22) Filed: Apr. 22, 2024

Related U.S. Application Data
(60) Provisional application No. 63/462,893, filed on Apr. 28, 2023.

(51) Int. Cl. B65F 1/12; B65F 1/14; B65F 3/02; B65F 3/04

(52) U.S. Cl. CPC B65F 1/122; B65F 1/14; B65F 3/041; B65F 2003/025

(57) ABSTRACT

An intermediate container system for detecting a waste receptacle includes an intermediate container and a processor. The intermediate container includes a container, an extension arm coupled to the container, a manipulator coupled to a distal end of the extension arm, and a camera configured to obtain image data associated with a target area proximate the intermediate container. The processor is configured to generate, based on the image data, a pose candidate located within the target area. The processor is also configured to verify if the pose candidate matches a template representation corresponding to the waste receptacle. Responsive to the pose candidate matching the template representation, the processor is also configured to determine a location of the waste receptacle. The processor is also configured to operate at least one of the extension arm or the manipulator to move the manipulator based on the location of the waste receptacle.

### CROSS-REFERENCE TO RELATED PATENT APPLICATION

This application claims the benefit of and priority to U.S. Provisional Patent Application No. 63/462,893, filed Apr. 28, 2023, which is incorporated herein by reference in its entirety.

### BACKGROUND

Refuse vehicles collect a wide variety of waste, trash, and other material from residences and businesses. Operators of the refuse vehicles transport the material from various waste receptacles within a municipality to a storage or processing facility (e.g., a landfill, an incineration facility, a recycling facility, etc.). One area of interest with respect to improving collection speed is the automation of the waste receptable pick-up.

### SUMMARY

One embodiment relates to an intermediate container system for detecting an engaging a waste receptacle. The intermediate container system includes an intermediate container configured to couple to a refuse vehicle and a processor. The intermediate container includes a container defining an internal cavity configured to receive refuse from the refuse receptacle, an extension arm coupled to the container, a manipulator coupled to a distal end of the extension arm, and a camera configured to obtain image data associated with a target area proximate the intermediate container. The extension arm is configured to extend from the container. The manipulator is configured to engage the waste receptacle. The processor is configured to generate, based on the image data, a pose candidate located within the target area. The processor is also configured to verify if the pose candidate matches a template representation corresponding to the waste receptacle. Responsive to the pose candidate matching the template representation, the processor is also configured to determine a location of the waste receptacle. The processor is also configured to operate at least one of the extension arm or the manipulator to move the manipulator based on the location of the waste receptacle.

In some embodiments, responsive to the pose candidate not matching the template representation, the processor is further configured to limit operation of at least one of the extension arm or the manipulator. In some embodiments, operation of the at least one of the extension arm or the manipulator includes operating the at least one of the extension arm or the manipulator to move the manipulator to an engagement position, grasp the waste receptacle with the manipulator, lift the waste receptacle, empty contents of the waste receptacle into the internal cavity of the container, lower the waste receptacle, and release the waste receptacle, wherein the manipulator is positioned to grasp the waste receptacle when the manipulator is in the engagement position.

In some embodiments, prior to operating the manipulator to grasp the waste receptacle, the processor is also configured to determine, based on the image data, if the manipulator is in the engagement position. In some embodiments, responsive to the manipulator not being in the engagement position, the processor is also configured to further operate the at least one of the extension arm or the manipulator to move the manipulator to the engagement position.

In some embodiments, the camera is a first camera. In some embodiments, the intermediate container also includes a second camera configured to obtain the image data associated with the target area proximate the intermediate container.

In some embodiments, the pose candidate is a first pose candidate generated based on the image data of the first camera. In some embodiments, the processor is also configured to generate, based on the image data of the second camera, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine the location of the waste receptacle using the image data obtained by the first camera and the second camera to triangulate the location of the waste receptacle.

In some embodiments, the first camera is coupled to the container and the second camera is coupled to the extension arm. In some embodiments, the second camera is configured to extend from the container with the extension arm.

In some embodiments, the pose candidate is a first pose candidate generated based on the image data of the first camera. In some embodiments, the processor is also configured to determine a first pose location of the first pose candidate. In some embodiments, the processor is also configured to generate, based on the image data of the second camera, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine a second pose location of the second pose candidate. In some embodiments, responsive to a difference between the first pose location and the second pose location being less than a location error threshold, the processor is also configured to determine that the location of the waste receptacle is at least one of the first pose location, the second pose location, or an average of the first pose location and the second pose location.

In some embodiments, the pose candidate is a first pose candidate generated based on the image data of the camera when the camera is in a first position. In some embodiments, the processor is also configured to determine a first pose location of the first pose candidate. In some embodiments, the processor is also configured to generate, based on the image data of the camera when the camera is in a second position, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine a second pose location of the second pose candidate. In some embodiments, responsive to a difference between the first pose location and the second pose location being less than a location error threshold, the processor is also configured to determine that the location of the waste receptacle is at least one of the first pose location, the second pose location, or an average of the first pose location and the second pose location.

Another embodiment relates to a refuse vehicle. The refuse vehicle includes a lift assembly, an intermediate container coupled to the lift assembly, and a processor. The intermediate container includes a container defining an internal cavity configured to receive refuse from a waste receptacle, an extension arm coupled to the container, a manipulator coupled to a distal end of the extension arm, and a camera configured to obtain image data associated with a target area proximate the intermediate container. The extension arm configured to extend from the container in a direction transverse a direction of travel of the refuse vehicle. The processor is configured to generate, based on the image data, a pose candidate located within the target area. The processor is also configured to verify if the pose candidate matches a template representation corresponding to the waste receptacle. Responsive to the pose candidate matching the template representation, the processor is also configured to determine a location of the waste receptacle. The processor is also configured to operate at least one of the extension arm or the manipulator to move the manipulator based on the location of the waste receptacle.

In some embodiments, responsive to the pose candidate not matching the template representation, the processor is also configured to limit operation of at least one of the extension arm or the manipulator. In some embodiments, operation of the at least one of the extension arm or the manipulator includes operating the at least one of the extension arm or the manipulator to move the manipulator to an engagement position, grasp the waste receptacle with the manipulator, lift the waste receptacle, empty contents of the waste receptacle into the internal cavity of the container, lower the waste receptacle, and release the waste receptacle, wherein the manipulator is positioned to grasp the waste receptacle when the manipulator is in the engagement position.

In some embodiments, prior to operating the manipulator to grasp the waste receptacle, the processor is also configured to determine, based on the image data, if the manipulator is in the engagement position. In some embodiments, responsive to the manipulator not being in the engagement position, the processor is also configured to further operate the at least one of the extension arm or the manipulator to move the manipulator to the engagement position.

In some embodiments, the pose candidate is a first pose candidate generated based on the image data of the camera when the camera is in a first position. In some embodiments, the processor is also configured to determine a first pose location of the first pose candidate. In some embodiments, the processor is also configured to generate, based on the image data of the camera when the camera is in a second position, a second pose candidate located within the target area. In some embodiments, the processor is also configured to verify if the second pose candidate matches the template representation corresponding to the waste receptacle. In some embodiments, responsive to the second pose candidate matching the template representation, the processor is also configured to determine a second pose location of the second pose candidate. In some embodiments, responsive to a difference between the first pose location and the second pose location being less than a location error threshold, the processor is also configured to determine that the location of the waste receptacle is at least one of the first pose location, the second pose location, or an average of the first pose location and the second pose location.

In some embodiments, responsive to the difference between the first pose location and the second pose location being greater than the location error threshold, the processor is also configured to limit operation of at least one of the extension arm or the manipulator.

Still another embodiment relates to a method for detecting and engaging a waste receptacle. The method includes generating, based on image data obtained by a camera of an intermediate container configured to couple to a refuse vehicle, a pose candidate located within a target area proximate the intermediate container. The method also includes verifying if the pose candidate matches a template representation corresponding to the waste receptacle. Responsive to the pose candidate matching the template representation, the method also includes determining a location of the waste receptacle. The method also includes operating at least one of an extension arm of the intermediate container or a manipulator of the intermediate container to move the manipulator based on the location of the waste receptacle.

In some embodiments, responsive to the pose candidate not matching the template representation, the method also includes limiting operation of at least one of the extension arm or the manipulator. In some embodiments, operating the at least one of the extension arm or the manipulator includes operating the at least one of the extension arm or the manipulator to move the manipulator to an engagement position, grasp the waste receptacle with the manipulator, lift the waste receptacle, empty contents of the waste receptacle into an internal cavity of a container of the intermediate container, lower the waste receptacle, and release the waste receptacle, wherein the manipulator is positioned to grasp the waste receptacle when the manipulator is in the engagement position.

In some embodiments, prior to operating the manipulator to grasp the waste receptacle, the method also includes determining, based on the image data, if the manipulator is in the engagement position. In some embodiments, determining, based on the image data, if the manipulator is in the engagement position, the method also includes operating the at least one of the extension arm or the manipulator to move the manipulator to the engagement position.

In some embodiments, the pose candidate is a first pose candidate generated based on the image data of the camera when the camera is in a first position. In some embodiments, the method also includes determining a first pose location of the first pose candidate. In some embodiments, the method also includes generating, based on the image data of the camera when the camera is in a second position, a second pose candidate located within the target area. In some embodiments, the method also includes verifying if the second pose candidate matches the template representation corresponding to the waste receptacle. In some embodiments, responsive to the second pose candidate matching the template representation, the method also includes determining a second pose location of the second pose candidate. In some embodiments, responsive to a difference between the first pose location and the second pose location being less than a location error threshold, the method also includes determining that the location of the waste receptacle is at least one of the first pose location, the second pose location, or an average of the first pose location and the second pose location.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

FIG. 1 is a perspective view of a refuse vehicle, according to an exemplary embodiment;

FIG. 2 is a perspective view of a container attachment for the refuse vehicle of FIG. 1 having an extension arm in a retracted position, according to an exemplary embodiment;

FIG. 3 is a perspective view of a container attachment for the refuse vehicle of FIG. 1 having the extension arm in an extended position and a grabber assembly in a grab orientation, according to an exemplary embodiment;

FIG. 4 is a perspective view of the container attachment of FIG. 2 having the extension arm in a retracted position and the grabber assembly in a dump orientation, according to an exemplary embodiment;

FIG. 5 is a pictorial representation of a waste receptacle and template representation associated with the waste receptacle, according to an exemplary embodiment;

FIG. 6 is a flow diagram depicting a method for creating a representation of an object, according to an exemplary embodiment;

FIG. 7 is a block diagram showing a control system for detecting and picking up a waste receptacle, according to an exemplary embodiment;

FIG. 8 is a flow diagram depicting a method pipeline used to detect and locate a waste receptacle, according to an exemplary embodiment;

FIG. 9 is a flow diagram depicting an example of a modified Line2D gradient-response map method, according to an exemplary embodiment;

FIG. 10 is a pictorial representation of the verify candidate step of a method for detecting and locating a waste receptacle, according to an exemplary embodiment; and

FIG. 11 is a flow diagram depicting a method for detecting and picking up a waste receptacle, according to an exemplary embodiment.

### DETAILED DESCRIPTION

Before turning to the figures, which illustrate certain exemplary embodiments in detail, it should be understood that the present disclosure is not limited to the details or methodology set forth in the description or illustrated in the figures. It should also be understood that the terminology used herein is for the purpose of description only and should not be regarded as limiting.

According to an exemplary embodiment, a system (e.g., an intermediate container system, etc.) for detecting and picking up a waste receptacle coupled to an intermediate carry can for a refuse vehicle includes an arm coupled to the intermediate carry can for grasping the waste receptacle, a processor, a camera in communication with the processor for capturing an image, a database in communication with the processor for storing a template representation corresponding to the waste receptacle, and an arm-actuation module in communication with the processor and connected to the arm. Any of the arm, processor, camera, and database may be mounted on the intermediate carry can of the refuse vehicle. The processor is configured for generating a pose candidate based on the image, and verifying whether the pose candidate matches the template representation. The processor is further configured for calculating a location and/or an orientation of the waste receptacle when a match between the pose candidate and the template representation has been verified. The extension arm and the arm-activation module are configured to automatically move the arm in response to the calculated location of the waste receptacle. Such a system may advantageously allow an operator to verify the location of the waste receptacle relative to the arm coupled to the intermediate carry can and to align the arm with the waste receptacle without the operator needing to exit the refuse vehicle, or otherwise manually verify alignment between the receptacle and the arm (such as through visual inspection of the location of the receptacle relative to the arm, etc.). Among other benefits, aspects of the present disclosure enable incorporation of a receptacle detection and/or lift/grabber actuation system into a carry can that may be retrofit onto an existing refuse vehicle without requiring substantive changes to existing vehicle hardware and/or control systems.

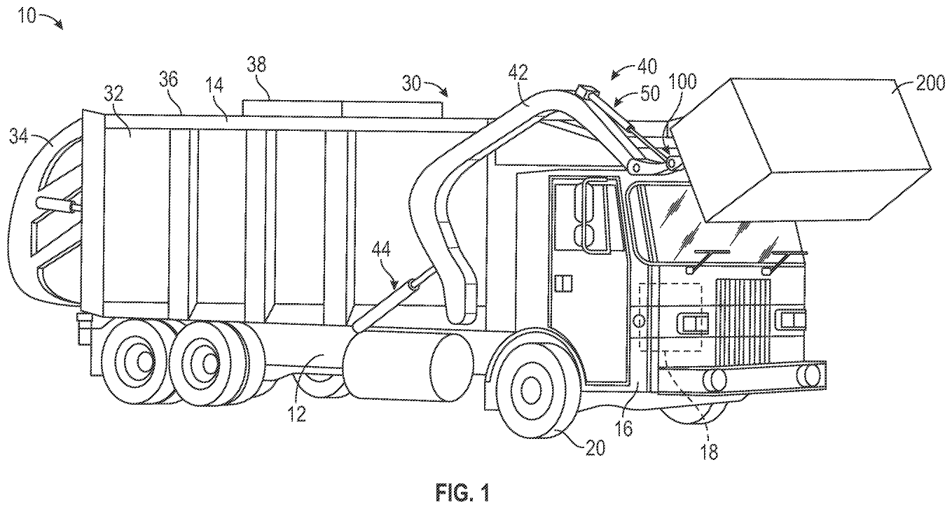

As shown in FIG. 1, a vehicle, shown as refuse vehicle 10 (e.g., a garbage truck, a waste collection truck, a sanitation truck, a recycling truck, etc.), is configured as a front-loading refuse truck. In other embodiments, the refuse vehicle 10 is configured as a side-loading refuse truck or a rear-loading refuse truck. In still other embodiments, the vehicle is another type of vehicle (e.g., a skid-loader, a telehandler, a plow truck, a boom lift, etc.). As shown in FIG. 1, the refuse vehicle 10 includes a chassis, shown as frame 12; a body assembly, shown as body 14, coupled to the frame 12 (e.g., at a rear end thereof, etc.); and a cab, shown as cab 16, coupled to the frame 12 (e.g., at a front end thereof, etc.). The cab 16 may include various components to facilitate operation of the refuse vehicle 10 by an operator (e.g., a seat, a steering wheel, actuator controls, a user interface, switches, buttons, dials, etc.).

As shown in FIG. 1, the refuse vehicle 10 includes a prime mover, shown as engine 18, coupled to the frame 12 at a position beneath the cab 16. The engine 18 is configured to provide power to a plurality of tractive elements, shown as wheels 20, and/or to other systems of the refuse vehicle 10 (e.g., a pneumatic system, a hydraulic system, etc.). The engine 18 may be configured to utilize one or more of a variety of fuels (e.g., gasoline, diesel, biodiesel, ethanol, natural gas, etc.), according to various exemplary embodiments. According to an alternative embodiment, the engine 18 additionally or alternatively includes one or more electric motors coupled to the frame 12 (e.g., a hybrid refuse vehicle, an electric refuse vehicle, etc.). The electric motors may consume electrical power from an on-board storage device (e.g., batteries, ultra-capacitors, etc.), from an on-board generator (e.g., an internal combustion engine, etc.), and/or from an external power source (e.g., overhead power lines, etc.) and provide power to the systems of the refuse vehicle 10.

According to an exemplary embodiment, the refuse vehicle 10 is configured to transport refuse from various waste receptacles within a municipality to a storage and/or processing facility (e.g., a landfill, an incineration facility, a recycling facility, etc.). As shown in FIG. 1, the body 14 includes a plurality of panels, shown as panels 32, a tailgate 34, and a cover 36. The panels 32, the tailgate 34, and the cover 36 define a collection chamber (e.g., hopper, etc.), shown as refuse compartment 30. Loose refuse may be placed into the refuse compartment 30 where it may thereafter be compacted. The refuse compartment 30 may provide temporary storage for refuse during transport to a waste disposal site and/or a recycling facility. In some embodiments, at least a portion of the body 14 and the refuse compartment 30 extend in front of the cab 16. According to the embodiment shown in FIG. 1, the body 14 and the refuse compartment 30 are positioned behind the cab 16. In some embodiments, the refuse compartment 30 includes a hopper volume and a storage volume. Refuse may be initially loaded into the hopper volume and thereafter compacted into the storage volume. According to an exemplary embodiment, the hopper volume is positioned between the storage volume and the cab 16 (i.e., refuse is loaded into a position of the refuse compartment 30 behind the cab 16 and stored in a position further toward the rear of the refuse compartment. In other embodiments, the storage volume is positioned between the hopper volume and the cab 16 (e.g., a rear-loading refuse vehicle, etc.).

As shown in FIG. 1, the refuse vehicle 10 includes a lift mechanism/system (e.g., a front-loading lift assembly, etc.), shown as lift assembly 40. The lift assembly 40 includes a pair of arms, shown as lift arms 42, coupled to the frame 12 and/or the body 14 on either side of the refuse vehicle 10 such that the lift arms 42 extend forward of the cab 16 (e.g., a front-loading refuse vehicle, etc.). In other embodiments, the lift assembly 40 extends rearward of the body 14 (e.g., a rear-loading refuse vehicle, etc.). In still other embodiments, the lift assembly 40 extends from a side of the body 14 (e.g., a side-loading refuse vehicle, etc.). The lift arms 42 may be rotatably coupled to frame 12 with a pivot (e.g., a lug, a shaft, etc.). As shown in FIG. 1, the lift assembly 40 includes first actuators, shown as lift arm actuators 44 (e.g., hydraulic cylinders, etc.), coupled to the frame 12 and the lift arms 42. The lift arm actuators 44 are positioned such that extension and retraction thereof rotates the lift arms 42 about an axis extending through the pivot, according to an exemplary embodiment.

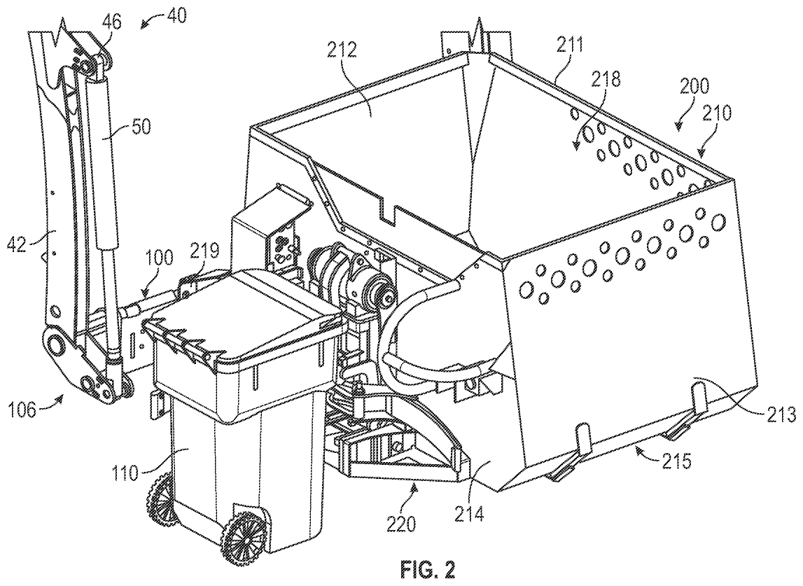

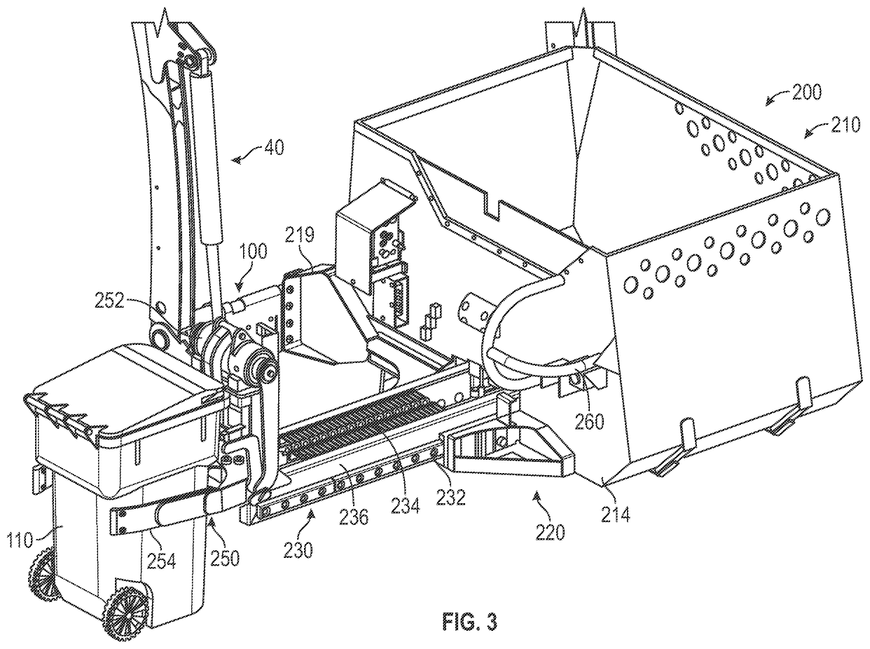

As shown in FIGS. 1 and 2, an attachment assembly, shown as attachment assembly 100, is coupled to the lift arms 42 of the lift assembly 40. As shown in FIGS. 2 and 3, the attachment assembly 100 is configured to engage with interfaces, shown as attachment interfaces 219, of a first attachment (e.g., a carry can, an intermediate container, etc.), shown as container attachment 200, to selectively and releasably secure the container attachment 200 to the lift assembly 40. In other embodiments, the attachment assembly 100 is configured to engage with one or more additional attachments (e.g., fork arms, etc.) to selectively and releasably secure the additional attachments to the lift assembly 40.

As shown in FIG. 1, the lift arms 42 are rotated by the lift arm actuators 44 to lift the container attachment 200 or other attachments over the cab 16. As shown in FIGS. 1 and 2, the lift assembly 40 includes second actuators, shown as articulation actuators 50 (e.g., hydraulic cylinders, etc.), extending between first brackets, shown as lift arm bracket 46, positioned along the lift arms 42 and second brackets, shown as attachment assembly brackets 106, positioned at opposing ends to of the attachment assembly 100. According to an exemplary embodiment, the articulation actuators 50 are positioned to articulate the attachment assembly 100. Such articulation may assist in tipping refuse out of the container attachment 200 and into the hopper volume of the refuse compartment 30 through an opening in the cover 36. The lift arm actuators 44 may thereafter rotate the lift arms 42 to return the container attachment 200 to the ground. According to an exemplary embodiment, a door, shown as top door 38 is movably coupled along the cover 36 to seal the opening thereby preventing refuse from escaping the refuse compartment 30 (e.g., due to wind, bumps in the road, etc.).

As shown in FIG. 2, the container attachment 200 includes a container, shown as a refuse container 210; a support, shown as arm support 220; an arm, shown as extension arm 230, a manipulator, shown as grabber arm 250, for collecting the waste from a receptacle (e.g., a bin, a residential receptacle, a can, etc.), shown as waste receptacle 110, and a camera (e.g., an image capture device, an image acquisition device, etc.), shown as camera 260, configured to capture an image of a target area proximate the container attachment 200 (e.g., in front of the container attachment 200, on a street-side or a curb-side of the container attachment 200, in a direction of extension of the extension arm 230, an area, etc.). The grabber arm 250 may include an arm-actuation module, shown as arm-actuation module 252, configured to operate the grabber arm 250. In some embodiments, the container attachment 200 also includes a distance sensor configured to generate sensor data corresponding to a distance between the distance sensor and the waste receptacle 110. In some embodiments, the container attachment 200 includes a plurality of the camera 260 (e.g., a first camera, a second camera, a third camera, etc.).

The refuse container 210 has a first wall, shown as front wall 213; an opposing second wall, shown as rear wall 212 (e.g., positioned between the cab 16 and the front wall 213, etc.); a first sidewall, shown as left sidewall 211; an opposing second sidewall, shown as right sidewall 214; and a bottom surface, shown as bottom 215. The front wall 213, the rear wall 212, the left sidewall 211, the right sidewall 214, and the bottom 215 cooperatively define an internal cavity, shown as intermediate compartment 218. According to an exemplary embodiment, the intermediate compartment 218 is configured to receive refuse from a refuse container (e.g., a residential garbage can, a recycling bin, etc.).

A waste receptacle is a container for collecting or storing garbage, recycling, compost, and other refuse, so that the garbage, recycling, compost, or other refuse can be pooled with other waste, and transported for further processing. Generally speaking, waste may be classified as residential, commercial, industrial, etc. As used here, a “waste receptacle” may apply to any of these categories, as well as others. Depending on the category and usage, a waste receptacle may take the form of a garbage can, a dumpster, a recycling “blue box”, a compost bin, etc. Further, waste receptacles may be used for curb-side collection (e.g., at certain residential locations), as well as collection in other specified locations (e.g., in the case of dumpster collection).

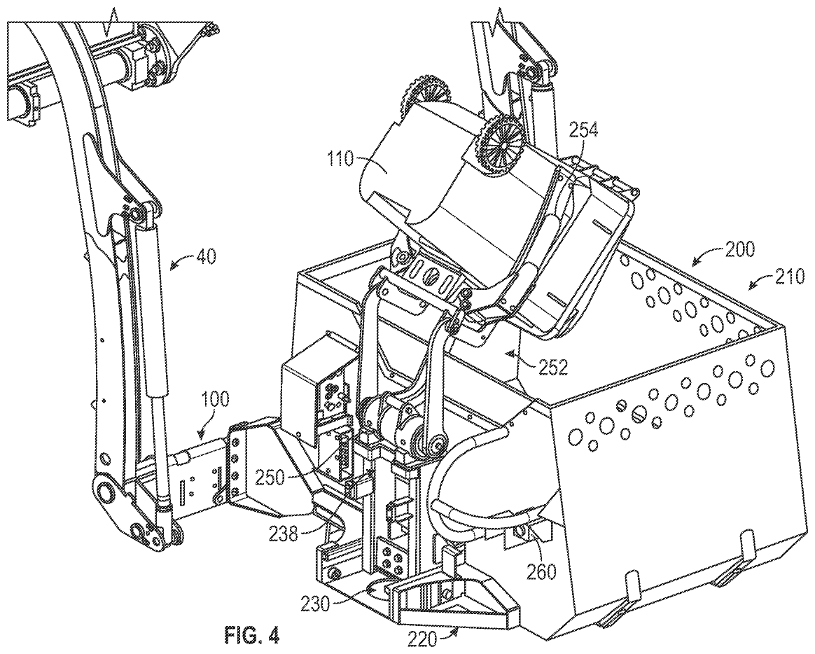

As shown in FIGS. 2 and 3, the arm support 220 is coupled to the right sidewall 214. In other embodiments the arm support 220 is otherwise positioned (e.g., coupled to the left sidewall 211, the rear wall 212, the front wall 213, the bottom 215, etc.). As shown in FIGS. 3 and 4, the extension arm 230 is coupled to the arm support 220. In other embodiments, the extension arm 230 is otherwise coupled to the container 210 (e.g., coupled to the right sidewall 214, coupled to the left sidewall 211, the rear wall 212, the front wall 213, the bottom 215, etc.).

As shown in FIGS. 3 and 4, the extension arm includes a slide, shown as telescoping slide 232, that is slidably received by the arm support 220 and recessed within the refuse container 210; an actuator, shown as extension actuator 234; and a frame assembly, shown as attachment frame 236, coupled to a free end, shown as distal end 238, of the telescoping slide 232. According to an exemplary embodiment, the extension actuator 234 is configured to extend the telescoping slide 232 from and retract the telescoping slide 232 into the refuse container 210 and the arm support 220. In various embodiments, the extension arm 230 includes a linear actuator, a scissor arm, a rack and pinion, a push chain, and/or still another type of actuator that facilitates extending and retracting the extension arm 230. According to the exemplary embodiment shown in FIGS. 2-4, the extension arm 230 is configured to extend laterally in a direction transverse to the direction of travel of the refuse vehicle 10. In other embodiments, the extension arm 230 extends in alternate directions (e.g., with the direction of travel, against the direction of travel, angled relative to the direction of travel, etc.). In other embodiments, the container attachment 200 does not include the extension arm 230.

According to the exemplary embodiment shown in FIGS. 3 and 4, the grabber arm 250 is coupled to the distal end 238 of the attachment frame 236 of the extension arm 230. In other embodiments, the grabber arm 250 is coupled to the right sidewall 214 (e.g., when the container attachment 200 does not include the extension arm 230, etc.) and/or otherwise coupled to the container 210 (e.g., coupled to the right sidewall 214, coupled to the left sidewall 211, the rear wall 212, the front wall 213, the bottom 215, etc.). The grabber arm 250 is configured to engage (e.g., grasp, grab, etc.) and move the waste receptacle 110. The particular configuration of the grabber arm 250 that is used in any particular embodiment of the container attachment 200 may be determined by such things as the type of the waste receptacle 110 that will be handled by the container attachment 200, the location of the grabber arm 250 relative to the container 210, the type of refuse vehicle 10 that will utilize the grabber arm 250, etc. The grabber arm 250 is generally movable, and may include a combination of telescoping lengths, flexible joints, etc., such that the grabber arm 250 can be moved anywhere within a three-dimensional volume that is within range of the grabber arm 250. For example, the grabber arm 250 may be configured to pivot around an axis positioned proximate the distal end 238 of the attachment frame 236 of the extension arm 230 and may be moved anywhere within the three-dimensional volume that is within the range of the grabber arm 250 when the grabber arm 250 is pivoted about the axis.

According to the exemplary embodiment shown in FIGS. 3 and 4, the grabber arm 250 includes an engagement device (e.g., a grabber, a tipper, a claw, etc.), shown as grabber 254, configured to engage (e.g., grab, grasp, etc.) the waste receptacle 110. The grabber 254 may utilize any combination of mechanical forces (e.g., friction, compression, etc.) or magnetic forces in order to engage the waste receptacle 110.

In some embodiments, the grabber 254 may be designed for complementary engagement with a particular type of the waste receptacle 110. According to the exemplary embodiment shown in FIGS. 3 and 4, the grabber 254 includes opposed figures that can be brought together or cinched around the waste receptacle 110. In other embodiments, the grabber 254 may include arms or levers for complementary engagement with receiving slots on the waste receptacle 110. Generally speaking, the grabber 254 may be designed to complement a specific waste receptacle, a specific type of waste receptacle, a general class of waste receptacles, etc.

As shown in FIGS. 3 and 4, the arm-actuation module 252 is configured to mechanically control and move the grabber arm 250. In some embodiments, the arm-actuation module 252 is also configured to mechanically control and move the grabber 254. The arm-actuation module 252 may include actuators, pneumatics, etc., for moving the grabber arm 250 and/or the grabber 254. The arm-actuation module 252 is controlled (e.g., electrically controlled, hydraulically controlled, etc.) by a control system for controlling the movement of the grabber arm 250. In various embodiments, the extension actuator 234 is also controlled by the control system for controlling the movement of the grabber arm 250 (e.g., the control system is also configured to control movement of the extension arm 230, etc.). In other embodiments, the arm-actuation module 252 is also configured to control movement of the extension arm 230. It should be understood that at least portions of the arm-actuation module 252 may be incorporated into the control system, which may comprise, for example, an electronic control unit (ECU) for the vehicle, so that the ECU controls movement of the extension actuator 234, the grabber arm 250, and/or the grabber 254. For example, in some embodiments, the arm-actuation module 252, or portions thereof, is software stored in memory of the control system. In other embodiments, the arm-actuation module, or portions thereof, is part of a control circuit that is separate from the engine control module. In other embodiments, portions of the control circuitry and/or software of the control system may be incorporated into the arm-actuation module 252, for example, so that the arm-actuation module 252 may form a standalone control system for identifying the presence of a receptacle and controlling actuation operations in association therewith.

In some embodiments, the control system is configured to provide control instructions (e.g., a control signal, control outputs, etc.) to the arm-actuation module 252 and the extension actuator 234 of the extension arm 230 based on the image data provided by the camera 260. In some embodiments, the control system is configured to provide control instructions to the arm-actuation module 252 and the extension actuator 234 of the extension arm 230 based on the image data provided by the camera 260 and sensor data provided by the distance sensor.

The extension actuator 234 is configured to move the extension arm 230 and the arm-actuation module 252 is configured to move and control the grabber arm 250 in order to pick up the waste receptacle 110 and dump the waste receptacle 110 into the intermediate compartment 218 of the container 210. In order to accomplish this, the control system that controls the extension actuator 234 and the arm-actuation module 252 verifies whether a pose candidate derived from the image data provided by the camera 260 matches a template representation corresponding to the waste receptacle 110 targeted by the container attachment 200.

According to the exemplary embodiment shown in FIGS. 3 and 4, the camera 260 is coupled to the right sidewall 214 of the container 210 so that, as the refuse vehicle 10 is driven along a path, the camera 260 is oriented to capture the image of the target area adjacent to or in proximity of the path of the refuse vehicle 10. In some embodiments, the camera 260 is configured (e.g., is oriented and/or directed, etc.) to capture the image of the target area proximate the container attachment 200 (e.g., in front of the container attachment 200, on a street-side or a curb-side of the container attachment 200, in a direction of extension of the extension arm 230, etc.). In some embodiments, the camera 260 is configured to generate image data associated with the image. In various embodiments, the container attachment 200 includes a plurality of the cameras 260 that are configured to capture images of a plurality of target areas proximate the container attachment 200 and generate image data associated with each of the images. In other embodiments, the camera(s) 1104 is otherwise coupled to the container 210 (e.g., coupled to the right sidewall 214, coupled to the left sidewall 211, the rear wall 212, the front wall 213, the bottom 215, etc.). In still other embodiments, the camera(s) 260 is coupled to other components of the container attachment 200 (e.g., the extension arm 230, etc.), the grabber arm 250, or other components of the refuse vehicle 10 (e.g., the lift assembly 40, the body 14, the cab 16, etc.). For example, one of the cameras 260 may be coupled to the attachment frame 236 of the extension arm 230 such that the one of the cameras 260 moves with the attachment frame 236 when the telescoping slide 232 of the extension arm 230 extends from and contracts towards the container 210.

In response to the image captured by the camera 260 including the waste receptacle 110, for example along a curb, the extension arm 230 and the control system may be configured to operate the arm-actuation module 252 to move the grabber arm 250 to a position (e.g., an engagement position, etc.) such that the grabber arm 250 may engage the waste receptacle 110 and dump the waste receptacle 110 into the container 210. In order to accomplish this, the control system that controls the extension arm 230 and the arm-actuation module 252 verifies whether a pose candidate derived from an image captured by the camera 260 matches a template representation corresponding to a target waste receptacle.

In order to verify whether a pose candidate matches a template representation, the template representation is created. Pose candidates will be described in further detail below, after the creation of template representations is described. In some embodiments, the control system that controls the extension actuator 234 and the arm-actuation module 252 is configured to create the template representations. In other embodiments, a different system (e.g., a cloud system, an off board computing system, a calibration system, an external system, etc.) is configured to create the template representations and provide the template representations to the control system (e.g., to free up processing power of the control system, if the control system does not have sufficient processing power to create the template representations, if the template representations are created in a controlled environment, etc.).

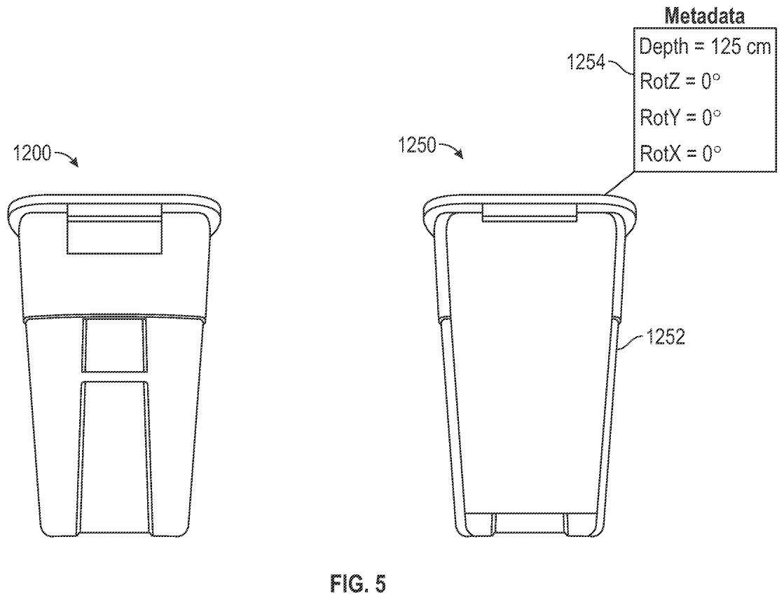

Referring to FIG. 5, there is shown an example of an object, shown as a waste receptacle 1200, and a representation of the object, shown as template representation 1250, created in respect of the waste receptacle 1200. The template representation 1250 is created by capturing multiple images of the waste receptacle 1200 depicting different poses (e.g., orientations, angles, distances, etc.) of the waste receptacle 1200. These multiple images are captured by taking pictures at various angles and scales (e.g., depths, distances from, etc.) around the waste receptacle 1200, such that the template representation 1250 includes a representation of the waste receptacle 1200 from each of the various angles and scales. In some embodiments, the images are associated with specific orientations of the waste receptacle 1200. For example, the images may focus on a front side of the waste receptacle 1200 or of the waste receptacle 1200 in an upright orientation, such that the template representation 1250 corresponds to the front side of the waste receptacle 1200 or the waste receptacle 1200 in the upright orientation.

In some embodiments, the images are associated with ideal orientations of the waste receptacle 1200 that may be engaged by the container attachment 200 (e.g., an operational orientation, a preferred orientation, etc.). For example, the images may be associated with a side of the waste receptacle 1200 that is ideally oriented toward the container attachment 200 for the container attachment 200 to engage the waste receptacle 1200 and empty the waste receptacle 1200 into the intermediate compartment 218 of the container attachment 200. The images associated with the ideal orientations of the waste receptacle 1200 may be used to form an ideal template representation that corresponds to the waste receptacle 1200 in the ideal orientations.

In other embodiments, the images are associated with non-ideal orientations of the waste receptacle 1200 that may not be engaged by the container attachment 200 (e.g., a non-operational orientation, an unpreferred orientation, etc.) For example, the images may be associated with the waste receptacle 1200 in a sideways orientation that makes it difficult for the container attachment 200 to engage the waste receptacle 1200 and empty the waste receptacle 1200 into the intermediate compartment 218 of the container attachment 200. The images associated with the non-ideal orientations of the waste receptacle 1200 may be used to form a non-ideal template representation that corresponds to the waste receptacle 1200 in the non-ideal orientations.

When a sufficient number of images have been captured of the waste receptacle 1200, the images are processed. The final product of this processing is the template representation 1250 associated with the waste receptacle 1200. In particular, the template representation 1250 includes gradient information data 1252 and pose metadata 1254. The template representation 1250 includes a set of individual templates corresponding to each of the poses of the waste receptacle 1200 in each of the images of the waste receptacle 1200. In some embodiments, the template representation 1250 is associated with the ideal orientations of the waste receptacle 1200 (e.g., based on the images of the waste receptacle 1200 being of the waste receptacle 1200 in the ideal orientation, etc.). In other embodiments, the template representation 1250 is associated with the non-ideal orientations of the waste receptacle 1200 (e.g., based on the images of the waste receptacle 1200 being of the waste receptacle 1200 in the non-ideal orientation, etc.).

The gradient information data 1252 is obtained along the boundary of the waste receptacle 1200 as found in the multiple images. The pose metadata 1254 are obtained from pose information corresponding with each of the images, such as the angles and the distances at which each of the images was captured relative to the waste receptacle 1200 (e.g., the angles and the distances of the camera relative to the waste receptacle 1200 for each of the multiple images, etc.). For example, the pose metadata 1254 for the template representation 1250 shown in FIG. 5 includes a depth of 125 cm (e.g., the camera that captured the individual template shown of the template representation 1250 was 125 cm away from the waste receptacle 1200, etc.), with no rotation about the X, Y, or Z axes (e.g., the camera was angled straight on to a front of the waste receptacle 1200, etc.).

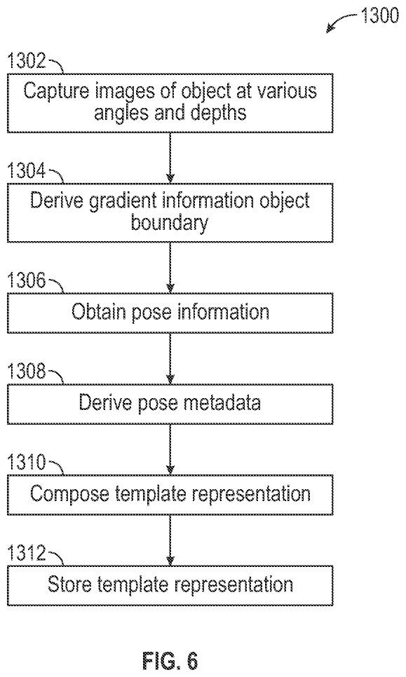

Referring to FIG. 6, there is shown a method 1300 for creating a template representation (e.g., a representation, a virtual representation, etc.) of an object. The method begins at step 1302, when images of the object are captured at various angles and scales. In some instances, the images of the object are captured by the camera 260. In other embodiments, the images of the objects are captured by a camera other than the camera 260 (e.g., a calibration camera, a camera not positioned on the refuse vehicle 10, etc.). Each of the images are associated with pose information, such as the depth of the camera (e.g., a distance of the camera from the object, etc.), and the three-dimensional position and/or rotation of the camera in respect of a reference point or origin (e.g., a reference point on the object, etc.).

At step 1304, gradient information is derived for the object boundary for each of the images captured by the camera. For example, as shown in FIG. 5, the gradient information is represented by gradient information data 1252. As is shown in FIG. 5, a gradient field including the gradient information data 1252 corresponds to the boundaries (e.g., edges, outline, etc.) of the waste receptacle 1200.

At step 1306, the pose information associated with each of the images is obtained. For example, this may be derived from the position of the camera relative to the object when each of the images were captured, which can be done automatically or manually, depending on the specific camera and system used to capture the images.

At step 1308, pose metadata is derived for each of the images based on the pose information associated with each of the images. The pose metadata is derived according to a prescribed or pre-defined format or structure such that the metadata can be readily used for subsequent operations such as verifying whether a pose candidate matches a template representation and/or determining a location of the pose candidate using the template representation.

At step 1310, a template representation is composed using the gradient information and pose metadata that were previously derived. As such, the template representation includes gradient information and associated pose metadata corresponding to each of the images captured.

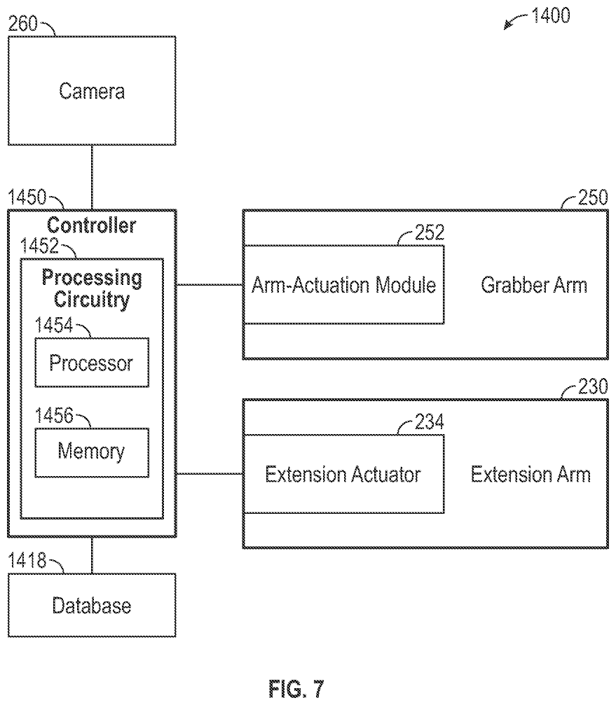

At step 1312, the template representation is stored so that it can be accessed or transferred for future use. Once the template representations have been created and stored, they can be used to verify pose candidates derived from real-time images, as will be described in further detail below. According to some embodiments, the template representations may be stored in a database. According to some embodiments, the template representations (including those in a database) may be stored on a non-transitory computer-readable medium. For example, the template representations may be stored in a database 1418, as shown in FIG. 7, and further described below.

Referring to FIG. 7, there is shown a system, shown as control system 1400, for detecting and engaging a waste receptacle (e.g., a waste retrieval system, an intermediate carry can control system, etc.). The control system 1400 includes the camera 260, the extension arm 230, the grabber arm 250, and a controller (e.g., a control circuit, etc.), shown as controller 1450. In some embodiments, the control system 1400 also includes the database 1418. According to some embodiments, the control system 1400 is positioned on the container attachment 200 of the refuse vehicle 10 (e.g., coupled to the container attachment 200, supported by the container attachment 200, mounted on the container attachment 200, etc.). In various embodiments, the container attachment 200 includes the control system 1400. In other embodiments, a first portion of the control system 1400 is positioned on the container attachment 200 and a second portion of the control system 1400 is not positioned on the container attachment 200. For example, the camera 260, the extension arm 230, and the grabber arm 250 may be positioned on the container attachment 200, but the controller 1450 may be positioned on a different portion of the refuse vehicle 10 and the database 1418 may be positioned remote of the refuse vehicle 10 (e.g., in the cloud, etc.).

The controller 1450 includes processing circuitry 1452 including a processor 1454 and memory 1456. The processing circuitry 1452 can be communicably connected with a communications interface of controller 1450 such that processing circuitry 1452 and the various components thereof can send and receive data via the communications interface. The processor 1454 can be implemented as a general purpose processor, an application specific integrated circuit (ASIC), one or more field programmable gate arrays (FPGAs), a group of processing components, or other suitable electronic processing components.

The memory 1456 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. The memory 1456 can be or include volatile memory or non-volatile memory. The memory 1456 can include database components, object code components, script components, or any other type of information structure for supporting the various activities and information structures described in the present application. According to some embodiments, the memory 1456 is communicably connected to the processor 1454 via the processing circuitry 1452 and includes computer code for executing (e.g., by at least one of the processing circuitry 1452 or the processor 1454) one or more processes described herein.

The controller 1450 is configured to receive inputs (e.g., image data, sensor data, etc.) from the camera 260 and/or the distances sensor, according to some embodiments. In particular, the controller 1450 may receive the image data from the camera 260 associated with an object (e.g., the waste receptacle 110, etc.) located in the target area of the camera 260. The controller 1450 may be configured to provide control outputs (e.g., control decisions, control signals, etc.) to the extension actuator 234 of the extension arm 230 and/or the arm-actuation module 252 of the grabber arm 250 to operate the container attachment 200 to pick up the waste receptacle 110 and empty the waste receptacle 110 into the intermediate compartment 218 of the container attachment 200 based on the inputs received by the controller 1450. The controller 1450 may also be configured to receive feedback from the camera 260, the extension actuator 234 of the extension arm 230 and/or the arm-actuation module 252 of the grabber arm 250. In some embodiments, the controller 1450 is configured to provide updated control outputs to the extension actuator 234 of the extension arm 230 and/or the arm-actuation module 252 of the grabber arm 250 based on the feedback received by the controller 1450.

The database 1418 may be configured to store data, such as the template representation generated by the method 1300. The database 1418 may interface with the controller 1450 to provide the data stored in the database 1418 to the controller 1450. In some embodiments, the database 1418 is positioned on the refuse vehicle 10. In other embodiments, the database 1418 is a remote database that is external from the refuse vehicle 10. The database 1418 may interface with the controller 1450 through wiring or wirelessly (e.g., via a network, via Bluetooth, etc.) to provide the data stored in the database 1418 to the controller 1450.

In operation, the camera 260 captures real-time images adjacent to the container attachment 200 as the refuse vehicle 10 is driven along a path and generates image data associated with the real-time images. For example, the path may be a residential street with garbage cans placed along the curb and the camera 260 may capture images of the garbage cans placed along the curb. The camera 260 provides (e.g., communicates, etc.) the image data associated with the real-time images to the controller 1450. In some embodiments, the image data may be communicated from the camera 260 to the controller 1450 using additional components such as memory, buffers, data buses, transceivers, etc. In some embodiments, the sensor data from the distance sensor may be provided from the distance sensor to the controller 1450. In various embodiments, the controller 1450 acquires the image data from the camera 260 and/or the sensor data from the distance sensor.

The controller 1450 is configured recognize if a waste receptacle is depicted in the image associated with the image data acquired from the camera 260 using the template representation stored in the database 1418. For example, the controller 1450 may analyze the image data to determine if the image associated with the image data depicts (e.g., includes, etc.) an object that corresponds to the template representation. If the controller 1450 determines that the image depicts an object that corresponds to the template representation, the controller 1450 may determine that a waste receptacle is located in the target area of the camera 260. In some embodiments, once the controller 1450 has determined that the waste receptacle is located in the target area of the camera 260, the controller 1450 may determine a location and/or an orientation of the waste receptacle in the target area based on the image data and/or the sensor data from the distance sensor and provide control outputs (e.g., control signals, etc.) to the extension actuator 234 of the extension arm 230 and/or the arm-actuation module 252 of the grabber arm 250 to operate the container attachment 200 to engage the waste receptacle based on the determined location and/or orientation. If the controller 1450 determines that the image data does not include an object that corresponds to the template representation, the controller 1450 may determine that a waste receptacle is not located in the target area of the camera 260.

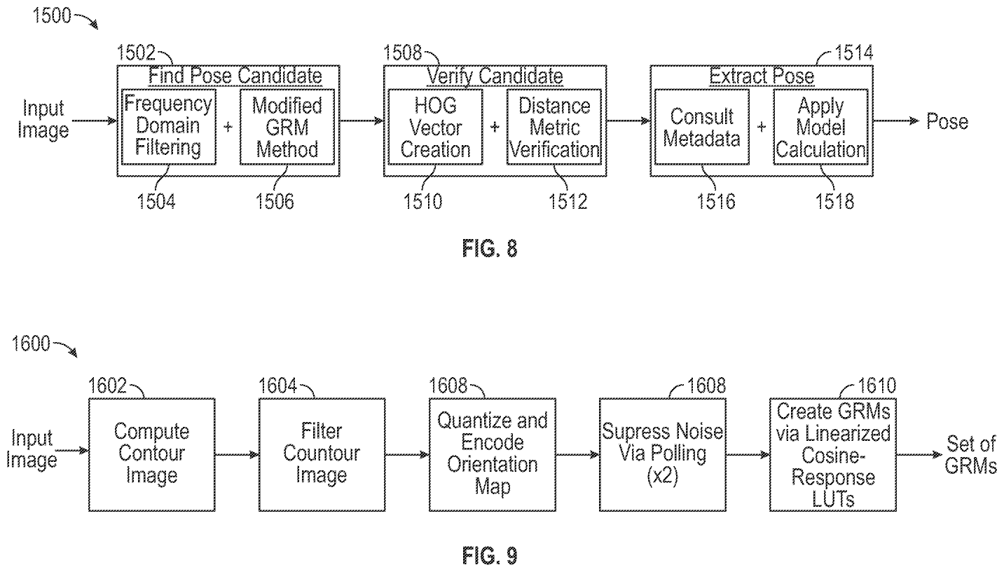

Referring to FIG. 8, a method 1500 for detecting and locating a waste receptacle is shown. In some embodiments, the method 1500 is performed by the controller 1450 to detect and locate a waste receptacle. In other embodiments, a different system performs the method 1500 to detect and locate a waste receptacle (e.g., an external system, etc.). For example, the controller 1450 may provide the image data to a cloud computing system (e.g., via a network, etc.) and the cloud computing system may detect and locate the waste receptacle. The method 1500 can be described as including step 150 of generating a pose candidate, step 1508 of verifying the pose candidate, and step 1514 of calculating the location of the recognized waste receptacle (i.e., extracting the pose).

The step 1502 of generating a pose candidate can be described in terms of frequency domain filtering 1504 and a gradient-response map method 1506. The step 1508 of verifying the pose candidate can be described in terms of creating a histogram of oriented gradients (HOG) vector 1510 and a distance-metric verification 1512. The step 1514 of extracting the pose (in which the location of the recognized waste receptacle is calculated) can be described in terms of step 1516 of consulting the pose metadata and step 1518 of applying a model calculation. The step 1516 of consulting the pose metadata generally requires retrieving the pose metadata from the database 1418.

Referring to FIG. 9, there is shown a method 1600 for implementing the step 1502 of generating the pose candidate. The method 1600 is a modified Line2D for implementing the step 1502 of generating the pose candidate. A Line2D method can be performed by the controller 1450, and the instructions for a Line2D method may generally be stored in the memory 1456 of the controller 1450. In other embodiments, a different system performs the method 1600 to implement the step 1502 of generating the pose candidate (e.g., an image processing system, etc.). For example, the controller 1450 may provide the image data to an external image processing system (e.g., via a network, etc.) and the external image processing system may implement the step 1502 of generating the pose candidate.

A standard Line2D method can be considered to include step 1602 of computing a contour image, step 1606 of quantizing and encoding an orientation map, step 1608 of suppressing noise via polling, and step 1610 of creating gradient-response maps (GRMs) via look-up tables (LUTs). In the method 1600 as depicted, step 1604 of filtering a contour image has been added as compared to the standard Line2D method. Furthermore, step 1608 of suppressing noise via polling and step 1610 of creating GRMs via LUTs have been modified as compared to the standard Line2D method.

The step 1604 of filtering the contour image converts the image data to the frequency domain from the spatial domain, applies a high-pass Gaussian filter to the spectral component, and then converts the processed image data back to the spatial domain. The step 1604 of filtering the contour image component can reduce the presence of background textures in the image data, such as grass and foliage.

The step 1608 of suppressing noise via polling is modified from a standard Line2D method by adding a second iteration of the process to the pipeline. In other words, polling can be performed twice instead of once, which can help reduce false positives in some circumstances.

The step 1610 of creating GRMs via LUTs is modified from a standard Line2D method by redefining the values used in the LUTs. Whereas a standard Line2D method may use values that follow a cosine response, the values used in the LUTs in the modified component of the step 1610 follow a linear response.

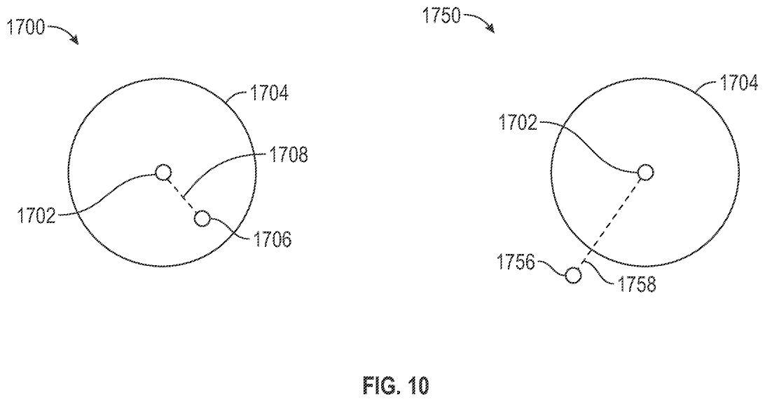

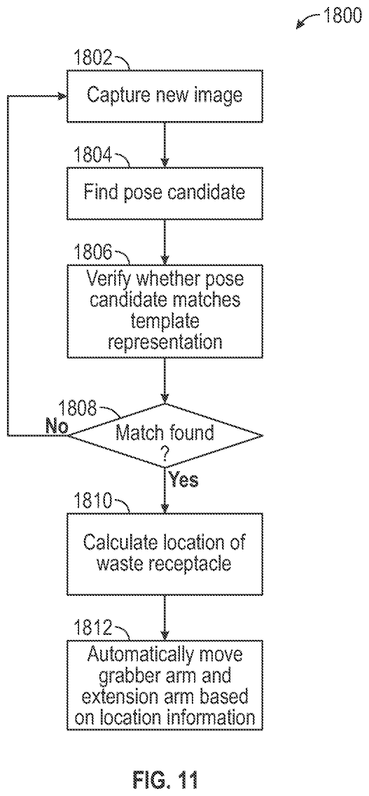

Referring to FIG. 10, there is shown a pictorial representation of the step 1508 of verify the pose candidate. Two examples are shown in FIG. 10. The first example 1700 depicts a scenario in which a match is found between the HOG of the template representation and the HOG of the pose candidate. The second example 1750 depicts a scenario in which a match is not found. In each example 1700 and 1750, the HOG of a template representation 1702 is depicted at the center of a circle that represents a pre-defined threshold 1704.

Example 1700 depicts a scenario in which the HOG of a pose candidate 1706 is within the circle. In other words, a difference 1708 (shown as a dashed line) between the HOG of the template representation 1702 and the HOG of the pose candidate 1706 is less than the pre-defined threshold 1704. In this case, a match between the pose candidate and the template representation can be verified.

Example 1750 depicts a scenario in which the HOG of a pose candidate 1756 is outside the circle. In other words, the difference 1758 between the HOG of the template representation 1702 and the HOG of the pose candidate 1756 is more than the pre-defined threshold 1704. In this case, a match between the pose candidate and the template representation cannot be verified.

Referring again to FIG. 8, when the match between the pose candidate and the template representation has been verified at step 1508, the method 1500 proceeds to the step 1514 of extracting the pose. The step 1514 of extracting the pose exploits the pose metadata stored during the creation of the template representation of the waste receptacle. This step calculates the location of the waste receptacle (e.g., the angle and scale) by comparing the pose candidate to the template representation and determining a data point of the pose metadata that corresponds with the pose candidate based on an alignment between the pose candidate and the template representation. For example, the pose candidate may be compared with the template representation to determine an orientation and/or location of the template representation relative to a portion of the vehicle (e.g., an angle relative to the template representation and/or a distance between the vehicle, the lift arms, or the container attachment and the template representation, etc.) that corresponds with the pose candidate. The data point of the pose metadata can then be selected that corresponds with the orientation and/or the location of the template representation relative to the portion of the vehicle. The orientation and/or location of the waste receptacle relative to the portion of the vehicle may then be determined by using known geometry of the container attachment 200 (e.g., a position of the camera 260 on the container 210, etc.) and the data point of the pose meta data that corresponds to the pose candidate.

In some embodiments, the location of the waste receptacle may be determined in relation to the container attachment 200. For example, the location of the waste receptacle may include three dimensional coordinates relative to an origin at a point associated with the container attachment 200. The location of the waste receptacle can be calculated using the pose metadata, the intrinsic parameters of the camera (e.g., focal length, feature depth, etc.), and a pin-hole model. For example, the pose candidate found during step 1508 may be compared to the pose meta data associated with the orientation of the template representation that corresponds with the pose candidate to determine a distance and an angle of the waste receptacle from the camera 260 positioned on the container attachment 200 by matching the pose candidate with the orientation of the template representation and determining the pose metadata associated with the orientation of the template representation. The location of the waste receptacle in relation to the container attachment 200 may then be determined using the pose metadata and known geometry of the container attachment 200.

Referring again to FIG. 7, once the location of the waste receptacle has been calculated, the controller 1450 can generate the control outputs for the extension actuator 234 and/or the arm-actuation module 252 based on the location of the waste receptacle to operate the extension arm 230 and the grabber arm 250 to position the grabber arm 250 in an engagement position where the grabber arm 250 may engage the waste receptacle. In other embodiments, the control outputs for the extension actuator 234 and/or the arm-actuation module 252 may be provided by another controller than the controller 1450, including controllers that are integrated with the extension actuator 234 and/or the arm-actuation module 252, based on the location of the waste receptacle calculated by the controller 1450.

In some embodiments, the controller 1450 can also generate control outputs for the engine 18 and/or the wheels 20 of the refuse vehicle 10 based on the location of the waste receptacle to operate the engine 18 and the wheels 20 to move the refuse vehicle 10 in order to position the grabber arm 250 in the engagement position where the grabber arm 250 may engage the waste receptacle. For example, if the extension arm 230 is configured to extend transverse to the direction of travel of the refuse vehicle 10 and the grabber arm 250 is configured to pivot about the extension arm 230, the operation of the extension arm 230 and the grabber arm 250 may not be sufficient to position the grabber arm 250 in the engagement position. For example, if the waste receptacle is positioned forward of the container attachment 200, the operation of the extension arm 230 and the grabber arm 250 may not be sufficient to position the grabber arm 250 in the engagement position. As a result, the controller 1450 can generate the control outputs for the engine 18, the wheels 20, the extension actuator 234 and/or the arm-actuation module 252 to position the grabber arm 250 in the engagement position.

In some embodiments, the controller 1450 can also generate control outputs for the lift arm actuators 44 and/or the articulation actuators 50 of the refuse vehicle 10 based on the location of the waste receptacle to operate the lift assembly 40 in order to position the grabber arm 250 in the engagement position where the grabber arm 250 may engage the waste receptacle. For example, if the waste receptacle is positioned above the container attachment 200, the operation of the extension arm 230 and the grabber arm 250 may not be sufficient to position the grabber arm 250 in the engagement position. As a result, the controller 1450 can generate the control outputs for the lift arm actuators 44, the articulation actuators 50, the extension actuator 234 and/or the arm-actuation module 252 to position the grabber arm 250 in the engagement position.

Referring to FIG. 11, a method for detecting and engaging a waste receptacle (e.g., a method for operating an intermediate can system for detecting and engaging a waste receptacle, etc.), shown as method 1800. In some embodiments, the method 1800 is performed by the controller 1450 to detect and engage the waste receptacle. In other embodiments, a different controller performs the method 1800 (e.g., a controller positioned on the refuse vehicle 10, a remote controller, etc.). The method 1800 begins at step 1802, when a new image is captured. For example, the new image may be captured by the camera 260, mounted on container attachment 200 as the refuse vehicle 10 is driven along a path. According to some embodiments, the camera 260 may be a video camera, capturing real-time images at a particular frame rate. In some embodiments, the method 1800 begins when a plurality of images are captured the plurality of the cameras 260 mounted on the container attachment 200.

At step 1804, the method 1800 includes finding a pose candidate based on the image. For example, the method may identify a waste receptacle in the image. According to some embodiments, step 1804 may include the steps of filtering the image and generating a set of gradient-response maps. For example, filtering the image may be accomplished by converting the image to the frequency domain, obtaining a spectral component of the image, applying a high-pass Gaussian filter to the spectral component, and then returning the image back to its spatial representation. According to some embodiments, step 1804 may include a noise suppression step. For example, noise can be suppressed via polling, and, in particular, superior noise-suppression results can be obtained by performing the polling twice (instead of once). In some embodiments, the method 1800 includes finding a pose candidate based on each of the images captured by the cameras 260. In some embodiments, step 1804 includes finding the pose candidate based on the multiple of the images.

At step 1806, the method 1800 includes verifying whether the pose candidate matches the template representation. According to some embodiments, this is accomplished by comparing an HOG of the template representation with an HOG of the pose candidate. The difference between the HOG of the template representation and the HOG of the pose candidate can be compared to a pre-defined threshold such that, if the difference is below the threshold, then the method determines that a match has been found; and if the difference is above the threshold, then the method determines that a match has not been found. In some embodiments, the method 1800 includes verifying whether each of the pose candidates (e.g., a first pose candidate, a second pose candidate, etc.) associated with the multiple of the images (e.g., a first image, a second image, etc.) match the template representation.

At step 1808, the method 1800 includes querying a match between the pose candidate and the template representation during the step 1806. If a match is not found—i.e., if the waste receptacle (or other target object) was not found in the image-then the method returns to step 1802, such that a new image is captured, and the method proceeds with the new image. If, on the other hand, a match is found, then the method proceeds to step 1810. In some embodiments, the method 1800 includes querying if each of the matches between each of the pose candidates and the template representation.

In some embodiments, the method 1800 includes preventing the operation of the extension arm 230 and/or the grabber arm 250 if the match is not found between the pose candidate and the template representation. For example, if the pose candidate is associated with a mailbox and does not match the template representation associated with the waste receptacle, the operation of the extension arm 230 and/or the grabber arm 250 may be prevented such that the extension arm 230 and/or the grabber arm 250 do not come into contact with the mailbox. In some embodiments, the method 1800 includes preventing the operation of the extension arm 230 and/or the grabber arm 250 if the match is not found between a portion of the pose candidates and the template representation (e.g., if a number of the pose candidates where the match is found between the pose candidates and the template representation is less than a pose threshold, etc.). For example, if the match is found between a first of the pose candidates from a first image associated with a first of the cameras 260 and the template representation, but the match is not found between a second of the pose candidates from a second image associated with a second of the cameras 260 and the template representation and between a third of the pose candidates from a third image associated with a third of the cameras 260 and the template representation, the operation of the extension arm 230 and/or the grabber arm 250 may be prevented when the pose threshold is two due to only one match being found between the pose candidates and the template representation. Utilizing the pose threshold may decrease a likelihood of a false positive of the match between the pose candidates and the template representation.

At step 1810, the method 1800 includes calculating the location of the waste receptacle. According to some embodiments, the location can be determined based on the pose metadata stored in the template representation that matches the pose candidate. For example, once a match has been determined at step 1808, then, effectively, the waste receptacle (or other target object) has been found. Then, by querying the pose metadata associated with the template representation, the particular pose (e.g., the angle and scale or depth) corresponding to the pose candidate can be determined. In some embodiments, the location can be determined based on the pose metadata stored in the template representation corresponding to the pose candidate and the data from the distance sensor.

In some embodiments, the location of the waste receptacle can be determined based on the pose metadata corresponding with each of the pose candidates associated with each of the images captured by the cameras 260 (e.g., a first image captured by a first of the cameras 260, a second image captured by a second of the cameras 260, etc.) that match the template representation. By calculating different locations of each of the pose candidates from each of the cameras 260, the location of the waste receptacle may be verified. For example, if a first of the pose candidates of a waste receptacle from a first of the cameras 260 corresponds to a first data point of the pose metadata and a second of the pose candidates of the waste receptacle from a second of the cameras 260 taken at a different orientation relative to the waste receptacle (e.g., a different orientation from the first of the pose candidates of the waste receptacle, etc.) corresponds to a second data point of the pose metadata, the first data point may be used to determine a first pose location of the first of the pose candidates and the second data point may be used to determine a second pose location of the second of the pose candidates. If the first pose location and the second pose location are substantially the same location (e.g., a difference between the first pose location and the second pose location is less than a location error threshold, etc.), then the location of the waste receptacle may be considered verified and the location of the waste receptacle may be determined based on the first pose location of the first of the pose candidates and the second pose location of the second of the pose candidates. For example, if the first pose location and the second pose location are substantially the same location, the location of the waste receptacle may be determined to be the first pose location, the second pose location, or an average location between the first pose location and the second pose location. If the first pose location and the second pose location are not substantially the same (e.g., the difference between the first pose location and the second pose location is greater than the location error threshold, etc.), then the location of the waste receptacle may not be considered verified.

In some embodiments, the location of the waste receptacle can be determined based on the pose meta data corresponding with each of the pose candidates associated with each of the images captured by one of the cameras 260 that are captured when the one of the cameras 260 is in different positions. For example, the different positions of the cameras 260 may correspond to different position of the extension arm 230 (e.g., an extended position, a retracted position, etc.) when the one of the cameras 260 is positioned on the extension arm 230. As another example, the different positions of the one of the cameras 260 may correspond to different positions of the refuse vehicle 10 as the refuse vehicle 10 is driven along the path. The one of the cameras 260 may capture a first image when the refuse vehicle 10 is in a first position that may be used to generate a first of the pose candidates and a second image when the refuse vehicle 10 is in a second position that may be used to generate a second of the pose candidates. The first of the pose candidates and the second of the pose candidates can then be used to determine the location of the waste receptacle proximate the path of the refuse vehicle 10.

In some embodiments, a triangulated location of the waste receptacle may be determined by triangulating the pose meta data corresponding with each of the pose candidates. The triangulation of the pose meta data corresponding with each of the pose candidates may be used to determine the location of the waste receptacle or to verify the location of the waste receptacle determined based on the pose metadata. For example, the triangulated location of the waste receptacle may be determined by triangulating the location of the pose candidate using angles associated with the pose meta data corresponding with each of the pose candidates.

At step 1812, the method 1800 includes automatically moving the extension arm 230 and/or the grabber arm 250 based on the location of the waste receptacle (e.g., location information associated with the waste receptacle, etc.). The extension arm 230 may be moved by the extension actuator 234 and the grabber arm 250 may be moved via the arm-actuation module 252. In some embodiments, the container attachment 200 is automatically moved by the articulation actuators 50. In some embodiments, the refuse vehicle 10 is automatically moved based on the location of the waste receptacle. The refuse vehicle 10 may be moved by the engine 18 and the wheels 20. In some embodiments, the lift assembly 40 is automatically moved based on the location of the waste receptacle. The lift assembly 40 may be moved by the lift arm actuators 44 and/or the articulation actuators 50.

In some embodiments, the step 1812 includes automatically moving the extension arm 230 and/or the grabber arm 250 based on the location of the waste receptacle if the match is found between a portion of the pose candidates and the template representation (e.g., if a number of the pose candidates where the match is found between the pose candidates and the template representation is greater than a pose threshold, etc.). For example, if the match is found between a first of the pose candidates from a first image and the template representation and between a second of the pose candidates from a second image and the template representation, but the match is not found between a third of the pose candidates from a third image and the template representation, the extension arm 230 and/or the grabber arm 250 may still be moved automatically when the pose threshold is two due to two matches being found between the pose candidates and the template representation.

According to some embodiments, the extension arm 230 and/or the grabber arm 250 may be moved entirely automatically. In other words, the control system 1400 may control the precise movements of the extension arm 230 and the grabber arm 250 necessary for the extension arm 230 to extend from the container 210, the grabber arm 250 to grasp the waste receptacle 110, the extension arm 230 to retract into the container 210, the grabber arm 250 to lift the waste receptacle 110, the grabber arm 250 to dump the waste receptacle 110 into the intermediate compartment 218 of the container 210, and then return the waste receptacle 110 to its original location, without the need for human intervention. In various embodiments, the refuse vehicle 10 and/or the lift assembly 40 may also be moved entirely automatically.

According to other embodiments, the extension arm 230 and/or the grabber arm 250 may be moved automatically towards the waste receptacle, but without the precision necessary to move the waste receptacle entirely without human intervention. In such a case, the control system 1400 may automatically move the extension arm 230 and/or the grabber arm 250 into sufficient proximity of the waste receptacle such that a human user is only required to control the extension arm 230 and/or the grabber arm 250 over a relatively short distance in order to engage the waste receptacle. In other words, according to some embodiments, the control system 1400 may move the extension arm 230 and/or the grabber arm 250 most of the way towards a waste receptacle by providing gross motor controls, and a human user (for example, using a joystick control), may only be required to provide fine motor controls. In various embodiments, the refuse vehicle 10 and/or the lift assembly 40 may also be moved automatically towards the waste receptacle, but without the precision necessary to move the waste receptacle entirely without human intervention. In such a case, the control system 1400 may automatically move the refuse vehicle 10 and/or the lift assembly 40 into sufficient proximity of the waste receptacle such that a human user is only required to control the refuse vehicle 10 and/or the lift assembly 40 over a relatively short distance in order to engage the waste receptacle.

In some embodiments, the step 1812 also includes monitoring a position of the grabber arm 250 during the automatic movement of the extension arm 230 and/or the grabber arm 250 to ensure that the grabber arm 250 reaches the engagement position where the grabber arm 250 may engage the waste receptacle. For example, during the automatic movement of the extension arm 230 and/or the grabber arm 250 the camera 260 may continue to provide image data to the controller 1450 that includes images associated with the waste receptacle 110 and the grabber arm 250. The controller 1450 may make adjustments to the automatic movement of the extension arm 230 and/or the grabber arm 250 responsive to the controller 1450 determining that the original automatic movement of the extension arm 230 and/or the grabber arm 250 will not result in the grabber arm 250 reaching the engagement position based on the image data received from the camera 260 (e.g., based on feedback image data received from the camera 260, etc.). As another example, the controller 1450 may utilize the image data provided by the camera 260 during the automatic movement of the extension arm 230 and/or the grabber arm 250 to determine that the grabber arm 250 has not reached the engagement position. In some embodiments, the controller 1450 may utilize the image data to limit the operation of the grabber arm 250 until the grabber arm 250 has reached the engagement position. For example, the controller 1450 may limit the operation of the grabber 254 of the grabber arm 250 until the grabber arm 250 has reached the engagement position to prevent the grabber 254 of the grabber arm 250 from closing before the grabber arm 250 has reached the engagement position.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the disclosure as recited in the appended claims.

It should be noted that the term “exemplary” and variations thereof, as used herein to describe various embodiments, are intended to indicate that such embodiments are possible examples, representations, or illustrations of possible embodiments (and such terms are not intended to connote that such embodiments are necessarily extraordinary or superlative examples).

The term “coupled”, and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References herein to the positions of elements (e.g., “top,” “bottom,” “above,” “below”) are merely used to describe the orientation of various elements in the figures. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

It is important to note that the construction and arrangement of the vehicle 10, the container attachment 200, the extension arm 230, the control system 1400, and components thereof as shown in the various exemplary embodiments is illustrative only. Additionally, any element disclosed in one embodiment may be incorporated or utilized with any other embodiment disclosed herein.

1. An intermediate container system for detecting and engaging a waste receptacle, the intermediate container system comprising:
an intermediate container configured to couple to a refuse vehicle, the intermediate container comprising:
a container defining an internal cavity configured to receive refuse from the waste receptacle;
an extension arm coupled to the container, the extension arm configured to extend from the container;
a manipulator coupled to a distal end of the extension arm, the manipulator configured to engage the waste receptacle; and
a camera configured to obtain image data associated with a target area proximate the intermediate container; and
a processor configured to:
generate, based on the image data, a pose candidate located within the target area;
verify if the pose candidate matches a template representation corresponding to the waste receptacle;
responsive to the pose candidate matching the template representation, determine a location of the waste receptacle; and
operate at least one of the extension arm or the manipulator to move the manipulator based on the location of the waste receptacle.

2. The intermediate container system of claim 1, wherein responsive to the pose candidate not matching the template representation, the processor is further configured to limit operation of at least one of the extension arm or the manipulator.

3. The intermediate container system of claim 1, wherein operation of the at least one of the extension arm or the manipulator includes operating the at least one of the extension arm or the manipulator to move the manipulator to an engagement position, grasp the waste receptacle with the manipulator, lift the waste receptacle, empty contents of the waste receptacle into the internal cavity of the container, lower the waste receptacle, and release the waste receptacle, wherein the manipulator is positioned to grasp the waste receptacle when the manipulator is in the engagement position.

4. The intermediate container system of claim 3, wherein prior to operating the manipulator to grasp the waste receptacle, the processor is further configured to:
determine, based on the image data, if the manipulator is in the engagement position; and
responsive to the manipulator not being in the engagement position, further operate the at least one of the extension arm or the manipulator to move the manipulator to the engagement position.

5. The intermediate container system of claim 1, wherein:
the camera is a first camera; and
the intermediate container further comprises a second camera configured to obtain the image data associated with the target area proximate the intermediate container.

6. The intermediate container system of claim 5, wherein the pose candidate is a first pose candidate generated based on the image data of the first camera; and
wherein the processor is further configured to:
generate, based on the image data of the second camera, a second pose candidate located within the target area;
verify if the second pose candidate matches the template representation corresponding to the waste receptacle; and
responsive to the second pose candidate matching the template representation, determine the location of the waste receptacle using the image data obtained by the first camera and the second camera to triangulate the location of the waste receptacle.

7. The intermediate container system of claim 6, wherein the first camera is coupled to the container and the second camera is coupled to the extension arm, wherein the second camera is configured to extend from the container with the extension arm.

8. The intermediate container system of claim 5, wherein the pose candidate is a first pose candidate generated based on the image data of the first camera; and
wherein the processor is further configured to:
determine a first pose location of the first pose candidate;
generate, based on the image data of the second camera, a second pose candidate located within the target area;
verify if the second pose candidate matches the template representation corresponding to the waste receptacle;
responsive to the second pose candidate matching the template representation, determine a second pose location of the second pose candidate; and
responsive to a difference between the first pose location and the second pose location being less than a location error threshold, determine that the location of the waste receptacle is at least one of the first pose location, the second pose location, or an average of the first pose location and the second pose location.

9. The intermediate container system of claim 1, wherein the pose candidate is a first pose candidate generated based on the image data of the camera when the camera is in a first position; and
wherein the processor is further configured to:
determine a first pose location of the first pose candidate;
generate, based on the image data of the camera when the camera is in a second position, a second pose candidate located within the target area;
verify if the second pose candidate matches the template representation corresponding to the waste receptacle;
responsive to the second pose candidate matching the template representation, determine a second pose location of the second pose candidate; and
responsive to a difference between the first pose location and the second pose location being less than a location error threshold, determine that the location of the waste receptacle is at least one of the first pose location, the second pose location, or an average of the first pose location and the second pose location.

10. A refuse vehicle comprising:
a lift assembly;
an intermediate container coupled to the lift assembly, the intermediate container comprising:
a container defining an internal cavity configured to receive refuse from a waste receptacle;
an extension arm coupled to the container, the extension arm configured to extend from the container in a direction transverse a direction of travel of the refuse vehicle;
a manipulator coupled to a distal end of the extension arm, the manipulator configured to engage the waste receptacle; and
a camera configured to obtain image data associated with a target area proximate the intermediate container; and
a processor configured to:
generate, based on the image data, a pose candidate located within the target area;
verify if the pose candidate matches a template representation corresponding to the waste receptacle;
responsive to the pose candidate matching the template representation, determine a location of the waste receptacle; and
operate at least one of the extension arm or the manipulator to move the manipulator based on the location of the waste receptacle.

11. The refuse vehicle of claim 10, wherein responsive to the pose candidate not matching the template representation, the processor is further configured to limit operation of at least one of the extension arm or the manipulator.

12. The refuse vehicle of claim 10, wherein operation of the at least one of the extension arm or the manipulator includes operating the at least one of the extension arm or the manipulator to move the manipulator to an engagement position, grasp the waste receptacle with the manipulator, lift the waste receptacle, empty contents of the waste receptacle into the internal cavity of the container, lower the waste receptacle, and release the waste receptacle, wherein the manipulator is positioned to grasp the waste receptacle when the manipulator is in the engagement position.

13. The refuse vehicle of claim 12, wherein prior to operating the manipulator to grasp the waste receptacle, the processor is configured to:
determine, based on the image data, if the manipulator is in the engagement position; and
responsive to the manipulator not being in the engagement position, further operate the at least one of the extension arm or the manipulator to move the manipulator to the engagement position.

14. The refuse vehicle of claim 10, wherein the pose candidate is a first pose candidate generated based on the image data of the camera when the camera is in a first position; and
wherein the processor is further configured to:
determine a first pose location of the first pose candidate;
generate, based on the image data of the camera when the camera is in a second position, a second pose candidate located within the target area;
verify if the second pose candidate matches the template representation corresponding to the waste receptacle;
responsive to the second pose candidate matching the template representation, determine a second pose location of the second pose candidate; and
responsive to a difference between the first pose location and the second pose location being less than a location error threshold, determine that the location of the waste receptacle is at least one of the first pose location, the second pose location, or an average of the first pose location and the second pose location.

15. The refuse vehicle of claim 14, responsive to the difference between the first pose location and the second pose location being greater than the location error threshold, the processor is further configured to configured to limit operation of at least one of the extension arm or the manipulator.

16. A method for detecting and engaging a waste receptacle, the method comprising:
generating, based on image data obtained by a camera of an intermediate container configured to couple to a refuse vehicle, a pose candidate located within a target area proximate the intermediate container;
verifying if the pose candidate matches a template representation corresponding to the waste receptacle;
responsive to the pose candidate matching the template representation, determining a location of the waste receptacle; and
operating at least one of an extension arm of the intermediate container or a manipulator of the intermediate container to move the manipulator based on the location of the waste receptacle.

17. The method of claim 16, wherein responsive to the pose candidate not matching the template representation, the method further comprises limiting operation of at least one of the extension arm or the manipulator.

18. The method of claim 16, wherein operating the at least one of the extension arm or the manipulator includes operating the at least one of the extension arm or the manipulator to move the manipulator to an engagement position, grasp the waste receptacle with the manipulator, lift the waste receptacle, empty contents of the waste receptacle into an internal cavity of a container of the intermediate container, lower the waste receptacle, and release the waste receptacle, wherein the manipulator is positioned to grasp the waste receptacle when the manipulator is in the engagement position.

19. The method of claim 18, wherein prior to operating the manipulator to grasp the waste receptacle, the method further comprises:
determining, based on the image data, if the manipulator is in the engagement position; and
responsive to the manipulator not being in the engagement position, further operating the at least one of the extension arm or the manipulator to move the manipulator to the engagement position.

20. The method of claim 19, wherein the pose candidate is a first pose candidate generated based on the image data of the camera when the camera is in a first position; and
wherein the method further comprises:
determining a first pose location of the first pose candidate;
generating, based on the image data of the camera when the camera is in a second position, a second pose candidate located within the target area;
verifying if the second pose candidate matches the template representation corresponding to the waste receptacle;
responsive to the second pose candidate matching the template representation, determining a second pose location of the second pose candidate; and
responsive to a difference between the first pose location and the second pose location being less than a location error threshold, determining that the location of the waste receptacle is at least one of the first pose location, the second pose location, or an average of the first pose location and the second pose location.
